(19) United States
(12) Patent Application Publication
(10) Pub. No.: US 2014/0129176 A1
(43) Pub. Date: May 8, 2014

(54) ESTIMATING THE GRAVITY VECTOR IN A WORLD COORDINATE SYSTEM USING AN ACCELEROMETER IN A MOBILE DEVICE

(71) Applicant: QUALCOMM INCORPORATED, San Diego, CA (US)

(72) Inventors: Arvind Ramanandan, San Diego, CA (US); Mahesh Ramachandran, San Diego, CA (US); Christopher Brunner, San Diego, CA (US); Murali Ramaswamy Chari, San Diego, CA (US)

(73) Assignee: QUALCOMM INCORPORATED, San Diego, CA (US)

(21) Appl. No.: 13/767,784

(22) Filed: Feb. 14, 2013

Related U.S. Application Data
(60) Provisional application No. 61/722,087, filed on Nov. 2, 2012.

(51) Int. Cl. G01P 13/02

(52) U.S. Cl. CPC G01P 13/02
USPC 702/141

(57) ABSTRACT

An accelerometer located within a mobile device is used to estimate a gravity vector on a target plane in a world coordinate system. The accelerometer makes multiple measurements, each measurement being taken when the mobile device is held stationary on the target plane and a surface of the mobile device faces and is in contact with a planar portion of the target plane. An average of the measurements is calculated. A rotational transformation between an accelerometer coordinate system and a mobile device's coordinate system is retrieved from a memory in the mobile device, where the mobile device's coordinate system is aligned with the surface of the mobile device. The rotational transformation is applied to the averaged measurements to obtain an estimated gravity vector in a world coordinate system defined by the target plane.

### CROSS REFERENCE TO RELATED APPLICATIONS

This application claims the benefit of U.S. Provisional Patent Application No. 61/722,087, filed Nov. 2, 2012, and titled “Determining the Gravity Vector in a World Coordinate System Using an Accelerometer in a Mobile Device,” the disclosure of which is hereby incorporated herein by reference in its entirety and for all purposes.

### BACKGROUND

The subject matter disclosed herein relates generally to the use of an accelerometer for measuring gravity vectors.

An accelerometer (also referred to as a motion sensor) measures proper acceleration, which is the acceleration it experiences relative to a freefall (or the inertia). Proper acceleration is associated with the phenomenon of weight experienced by a proof mass that resides in a frame of reference of the accelerometer. An accelerometer measures the weight per unit of the proof mass, a quantity also known as specific force, or g-force. Conceptually, an accelerometer behaves as a damped mass on a spring. When the accelerometer experiences acceleration, the position of the proof mass is displaced with respect to the frame. The displacement is measured to determine the acceleration.

A gyroscope (also referred to as a rotation sensor) measures the angular velocity of a system in the inertial reference frame. By using the original orientation of the system in the inertial reference frame as the initial condition and integrating the angular velocity, the system's current orientation can be known. Conceptually, a gyroscope is a spinning rotor which maintains its orientation based on the principle of conservation of angular momentum. This phenomenon can be used for measuring and maintaining orientation in many applications, such as compasses and stabilizers in aircraft and spacecraft.

Accelerometers and gyroscopes have been incorporated into a variety of consumer electronics. The integration of accelerometers and gyroscopes allows for more accurate and robust augmented reality (AR) applications, simultaneous localization and mapping (SLAM) applications, computer vision applications, navigation applications, stability control applications, and a wide range of other applications.

For many of the above-mentioned applications, e.g., for AR and computer vision applications, one of the assumptions is that the gravity vector in the target coordinate system is known. An example of a target coordinate system is the coordinate system in which an AR target is going to be displayed. However, this gravity vector is generally not known in practice, and is generally measured in response to a request from an application such as an AR or SLAM application. The accuracy requirement for the measurements is quite high (e.g., less than a degree); otherwise the measurements would be unusable. Higher accuracy would lead to a better performing application or more demanding use cases. Existing accelerometer-assisted techniques for measuring the gravity vector in the target coordinate system typically have low accuracy due to error accumulations in multiple transformation steps where each step may introduce errors.

### SUMMARY

An accelerometer located within a mobile device is used to estimate a gravity vector on a target plane in a world coordinate system. In one embodiment, a processor of the mobile device receives a plurality of measurements from the accelerometer. Each of the measurements is taken when the mobile device is held stationary on the target plane and a surface of the mobile device faces and is in contact with a planar portion of the target plane. The processor calculates an average of the measurements, and retrieves a rotational transformation between an accelerometer coordinate system and a device coordinate system from a memory in the mobile device, wherein the device coordinate system is aligned with the surface of the mobile device. The rotational transformation is applied to the averaged measurements to obtain an estimated gravity vector in a world coordinate system defined by the target plane.

In another embodiment, a mobile device comprises: an accelerometer, a memory to store a rotational transformation between a coordinate system of the accelerometer and a coordinate system of the mobile device, and a processor coupled to the memory and the accelerometer. The processor is configured to: receive a plurality of measurements from the accelerometer, each of the measurements being taken when the mobile device is held stationary on a target plane and a surface of the mobile device faces and is in contact with a planar portion of the target plane; calculate an average of the measurements; retrieve the rotational transformation from the memory, wherein the coordinate system of the mobile device is aligned with the surface of the mobile device; and apply the rotational transformation to the average to obtain an estimated gravity vector in a world coordinate system defined by the target plane.

In another embodiment, a computer program product comprises a computer-readable medium, which comprises code for: receiving a plurality of measurements from an accelerometer, each of the measurements being taken when the mobile device is held stationary on a target plane and a surface of the mobile device faces and is in contact with a planar portion of the target plane; calculating an average of the measurements; retrieving a rotational transformation between a coordinate system of the accelerometer and a coordinate system of the mobile device from a memory in the mobile device, wherein the coordinate system of the mobile device is aligned with the surface of the mobile device; and applying the rotational transformation to the average to obtain an estimated gravity vector in a world coordinate system defined by the target plane.

In yet another embodiment, a mobile device comprises: means for receiving a plurality of measurements from an accelerometer, each of the measurements being taken when the mobile device is held stationary on a target plane and a surface of the mobile device faces and is in contact with a planar portion of the target plane; means for calculating an average of the measurements; means for retrieving a rotational transformation between a coordinate system of the accelerometer and a coordinate system of the mobile device from a memory in the mobile device, wherein the coordinate system of the mobile device is aligned with the surface of the mobile device; and means for applying the rotational transformation to the average to obtain an estimated gravity vector in a world coordinate system defined by the target plane.

### BRIEF DESCRIPTION OF THE DRAWINGS

FIG. 1 is a block diagram of a mobile device in which embodiments of the invention may be practiced.

FIG. 2A and FIG. 2B illustrate examples of a side profile of the mobile device of FIG. 1.

FIG. 3A, FIG. 3B, FIG. 3C and FIG. 3D illustrate examples of a target plane relative to which the gravity vector is to be estimated.

FIG. 4 is a flow diagram illustrating a method for estimating the gravity vector in a world coordinate system using an accelerometer within a mobile device according to one embodiment.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

Embodiments of the invention provide a method for estimating the gravity vector with respect to a target plane using an accelerometer in a mobile device, such as a mobile phone. For AR applications, the target plane is a feature plane on which the AR target is going to be displayed. The target plane can have any orientation; for example, the target plane can be aligned with the horizontal axis, aligned with the vertical axis, or tilted with respect to the horizontal or vertical axis. This target plane defines a world coordinate system for AR applications. The mobile device can serve as a convenient tool for estimating or measuring the gravity vector in the world coordinate system. It is appreciated that the estimation technique described herein is not limited to AR applications; it is applicable to a wide range of applications where the target plane may be a plane relative to which the gravity vector is unknown and needs to be measured.

As used herein, the term “world coordinate system,” “tracking coordinate system” or “target coordinate system” refers to a coordinate system having a 2-D coordinate plane defined by the target plane. That is, the x-y (or x-z or y-z) coordinate plane of the world coordinate system is parallel to the target plane. The term “accelerometer coordinate system” refers to the coordinate system of the accelerometer within the mobile device. The term “device coordinate system” or “surface coordinate system” refers to a coordinate system having a 2-D coordinate plane defined by a surface of the mobile device. In one embodiment, a mobile device may have only one device coordinate system defined by one surface (either front or back surface) of the mobile device. This surface is referred to as a “coordinate surface” of the mobile device. For a mobile device having its front surface parallel to its back surface, both front and back surfaces of the mobile device can be the coordinate surface. If the front surface of a mobile device is not parallel to the back surface, only one surface (either front or back) of the mobile device that defines the device coordinate system is the coordinate surface. In another embodiment, a mobile device may have two device coordinate systems; one defined by the front surface and the other one defined by the back surface. The mobile device may select either the front surface or the back surface as the coordinate surface. In one embodiment, the mobile device can be configured to retrieve one of two rotational transformations from the memory for alignment with the front or back surface, where the two rotational transformations include a first transformation between the coordinate system of the accelerometer and the front surface of the mobile device, and a second transformation between the coordinate system of the accelerometer and the back surface of the mobile device.

In one embodiment, a user places the coordinate surface of the mobile device firmly on the target plane such that the coordinate surface is parallel to the target plane. After the mobile device is firmly placed and motionless, the accelerometer within the mobile device makes one or more measurements. Each measurement is a measured gravity vector in the accelerometer coordinate system. If the rotational transformation between the device coordinate system and the accelerometer coordinate system is known, a conversion engine in the mobile device can convert the gravity measurements from the accelerometer coordinate system to the device coordinate system. As the coordinate surface of the mobile device is parallel to the target plane, the gravity measurements in the device coordinate system are the same as those in the world coordinate system. The gravity measurements can be averaged over a time window to obtain an accurate estimate of the gravity vector relative to the target plane in the world coordinate system.

The gravity vector measured in the world coordinate system can be used for AR, SLAM and various other applications. In one embodiment, the accelerometer is factory-calibrated such that the coordinate system of the accelerometer aligns with the surface of the mobile device. Other calibration techniques, such as user-performed calibration, can also be used. The alignment result is a rotational transformation, which can be stored in the memory of the mobile device. Thus, a mobile device can be aligned (calibrated) once and the alignment result can be used in the subsequent measurements.

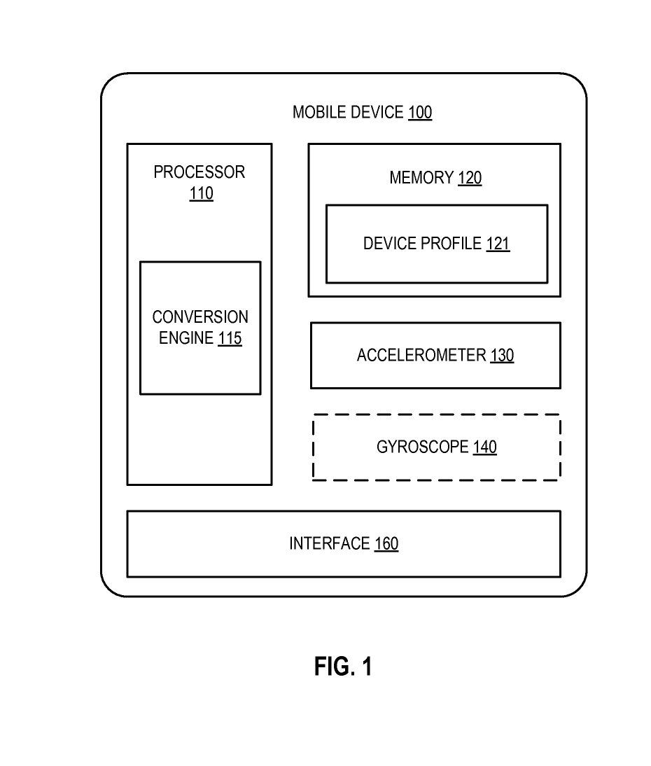

FIG. 1 is a block diagram illustrating a system in which embodiments of the invention may be practiced. The system may be a mobile device 100, which may include a processor 110, a memory 120, an interface 160 and one or more sensors such as an accelerometer 130 and a gyroscope 140. In one embodiment, the mobile device 100 may include both the accelerometer 130 and the gyroscope 140; in an alternative embodiment, the mobile device 100 may include only the accelerometer 130. It should be appreciated that the mobile device 100 may also include a display device, a user interface (e.g., keyboard, touch-screen, etc.), a power device (e.g., a battery), as well as other components typically associated with a mobile communication device. For example, the interface 160 may be a wireless transceiver to transmit and receive wireless signals through a wireless link to/from a wireless network, or may be wired interface for direct connection to networks (e.g., the Internet). Thus, the mobile device 100 may be a mobile phone (e.g., cell phone, smart phone, etc.), personal digital assistant, mobile computer, tablet, personal computer, laptop computer, e-reader, or any type of mobile device that has motion sensing and/or rotation sensing capabilities.

In one embodiment, the processor 110 may include a conversion engine 115, which may be implemented in hardware, firmware, software, or a combination of any of the above. In one embodiment, the processor 110 may be a general-purpose processor or a special-purpose processor configured to execute instructions for performing the operations of conversion engine 115 that retrieves a stored rotational transformation from the memory 120, where the rotational transformation transforms an acceleration measurement in the accelerometer coordinate system into a corresponding vector in the device coordinate system. The conversion engine 115 may apply the rotational transformation to accelerometer measurements to compute the gravity vector in the world coordinate system in a process to be described below.

The memory 120 may be coupled to the processor 110 to store instructions for execution by the processor 110. The memory 120 may store a device profile 121, which includes the rotational transformation between the accelerometer coordinate system and the device coordinate system. In an embodiment where the mobile device 100 may choose one of its surfaces as the coordinate surface, the memory 120 may store more than one rotational transformation; e.g., one rotational transformation for the front surface and another rotational transformation for the back surface. According to embodiments of the invention, the device profile 121 of the mobile device may store the rotational transformation with other sensor calibration parameters such as the measuring scale, crosstalk of sensors and the alignment between the sensors and the camera, sensor biases, if any, on the mobile device.

It should be appreciated that embodiments of the invention as will be hereinafter described may be implemented in conjunction with the execution of instructions by the processor 110 of the mobile device 100 and/or other circuitry of the mobile device 100 and/or other devices. Particularly, circuitry of the mobile device 100, including but not limited to the processor 110, may operate under the control of a program, routine, or the execution of instructions to execute methods or processes in accordance with embodiments of the invention. For example, such a program may be implemented in firmware or software (e.g. stored in the memory 120 and/or other locations) and may be implemented by processors, such as the processor 110, and/or other circuitry of the mobile device 100. Further, it should be appreciated that the terms processor, microprocessor, circuitry, controller, etc., refer to any type of logic or circuitry capable of executing logic, commands, instructions, software, firmware, functionality and the like.

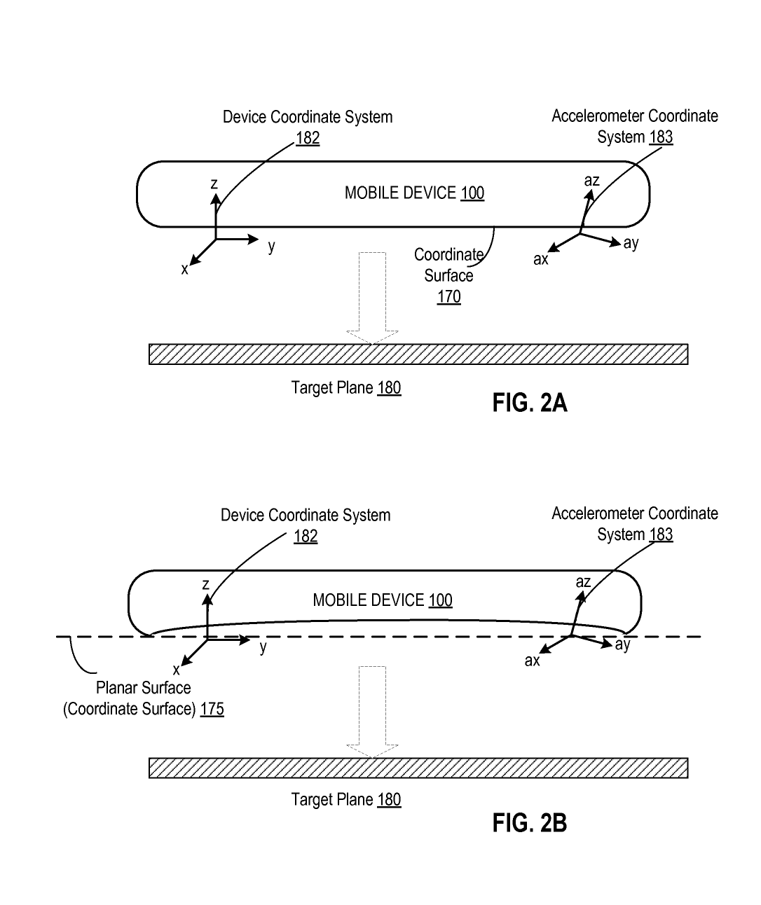

FIG. 2A illustrates a side profile of the mobile device 100 according to one embodiment. The mobile device 100, as viewed in FIG. 2A, has a top surface and a bottom surface, where the bottom surface may be either the front or back side of the mobile device 100. FIG. 2A shows that a device coordinate system 182 having an x-y coordinate plane parallel to the bottom surface. As such, the bottom surface is a coordinate surface 170 for the mobile device 100, which is the surface to which the device coordinate system 182 aligns. This coordinate surface 170 is to be placed on a target plane 180 that defines the world coordinate system.

FIG. 2B illustrates a side profile of the mobile device 100 according to another embodiment. The mobile device 100, as viewed in FIG. 2B, has a concaved bottom surface, where the concaved bottom surface may be either the front or back side of the mobile device 100. The convex hull of the concaved bottom surface defines a planar surface 175. FIG. 2B shows that the x-y coordinate plane of the device coordinate system 182 is parallel to the planar surface 175. As such, the planar surface 175 is the coordinate surface for the mobile device 100, which is the surface to which the device coordinate system 182 aligns. This coordinate surface is to be placed on the target plane 180 that defines the world coordinate system.

In an embodiment where the mobile device 100 can select either its front surface or the back surface as the coordinate surface, the selection is based on which surface of the mobile device 100 is placed and in contact with the target plane 180. The device coordinate system 182 is defined based on the selection. Once the selection is made, the mobile device 100 may retrieve the corresponding rotational transformation for the device coordinate system 182.

The accelerometer 130 measures the gravity vector when it is stationary. The accelerometer coordinate system 183 is the coordinate system in which all of the accelerometer measurements lie. The accelerometer coordinate system 183 is not necessarily aligned with the device coordinate system 182. The accelerometer coordinate system 183 and the device coordinate system 182 are misaligned when the x-y plane of the surface coordinate system 182 is not aligned with the ax-ay plane of the accelerometer coordinate system 183. The misalignment described herein is the rotational misalignment. This rotational misalignment can be calibrated by the factory manufacturing the mobile device 100, or by a user who performs a user calibration process. The calibration result is the rotational transformation stored in the memory 120 of FIG. 1. In one embodiment, the rotational transformation is in the form of a rotational matrix. The rotational transformation transforms an accelerometer measurement from the accelerometer coordinate system 183 into the device coordinate system 182. If the accelerometer coordinate system 183 is aligned with the device coordinate system 182, the rotational matrix is an identify matrix and no transformation is necessary.

The gravity vector g, which equals 9.81 m/s² measured at sea level, points straight down to the earth center. The gravity vector g may be represented by [0, 0, 9.81] in a coordinate system having a z axis pointing straight down to the earth center. The gravity vector measured by the accelerometer 130 is g′, which has the same vector length (9.81 m/s² measured at sea level) as the gravity vector g, but may be a rotated version of g due to the orientation of the accelerometer 130 and calibration errors. For example, the measured gravity vector g′ may be [5, 2.69, 8] in the accelerometer coordinate system 183. If the accelerometer coordinate system 183 and the device coordinate system 182 are aligned, the gravity vector in the device coordinate system 182 will also be g′. However, when the accelerometer coordinate system 183 and the device coordinate system 182 are misaligned, the gravity vector g″ in the device coordinate system 182 is further rotated from g′ by an angle in the 3-D Euclidian frame. The rotational transformation stored in the mobile device 100 is a transformation from g′ to g″. A bias exists in the gravity measurement if the length of the measured gravity vector is greater than 9.81. Techniques for removing biases from gravity measurements include the extended Kalman filtering, which produces accurate results when the amount of bias is small (e.g., within +/−3 degrees as sines and cosines can be approximated by straight lines in that region). Alternative filtering techniques may also be used.

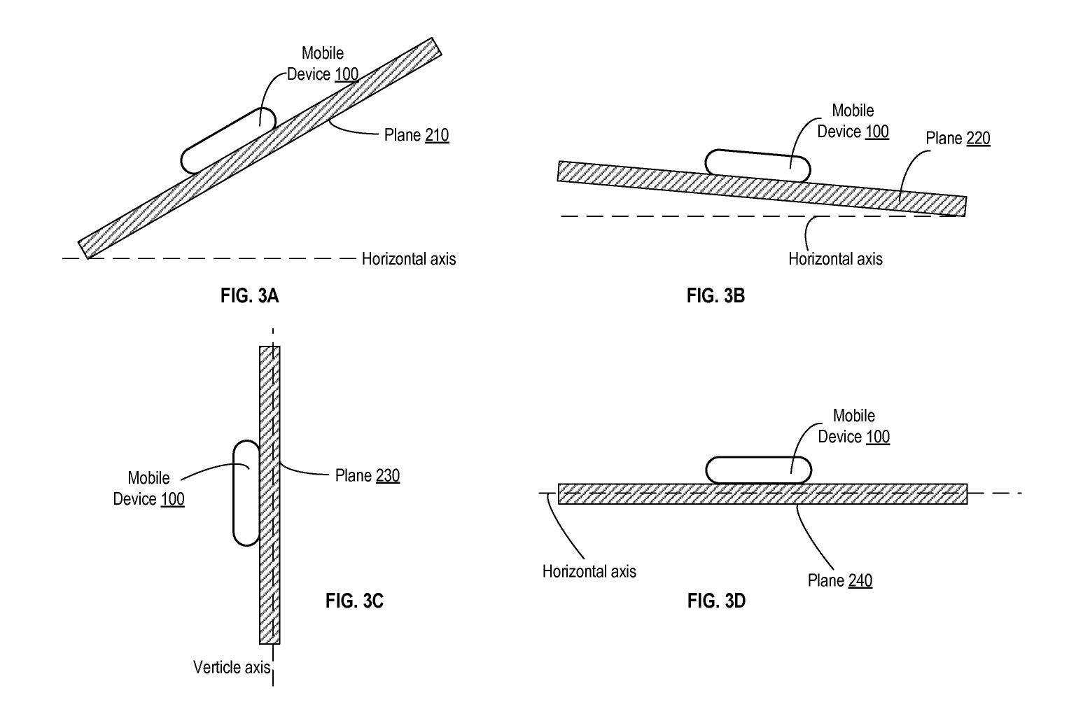

FIG. 3A-3D illustrate examples of target planes 210-240 with different orientations, such as tilted with respect to the horizontal axis (FIG. 3A and FIG. 3B), vertical (FIG. 3C) and horizontal (FIG. 3D) orientations. Each target plane 210-240 has a planar surface facing the mobile device 100, or at least a portion of the surface facing the mobile device 100 is planar. To estimate the gravity vector relative to the target plane 210-240, a user may hold the mobile device 100 firmly on the planar surface of the target plane without motion. The accelerometer 130 can then take measurements while the mobile device 100 is stationary and motionless. The surface of the mobile device 100 facing the target plane 210-240 is its coordinate surface (e.g., the surface 170 or 175 of FIG. 2A and FIG. 2B); that is, the mobile device's surface that is aligned with the device coordinate system 182. This coordinate surface (170 or 175) is held parallel to the planar surface of the target plane 210-240 when the accelerometer 130 takes measurements.

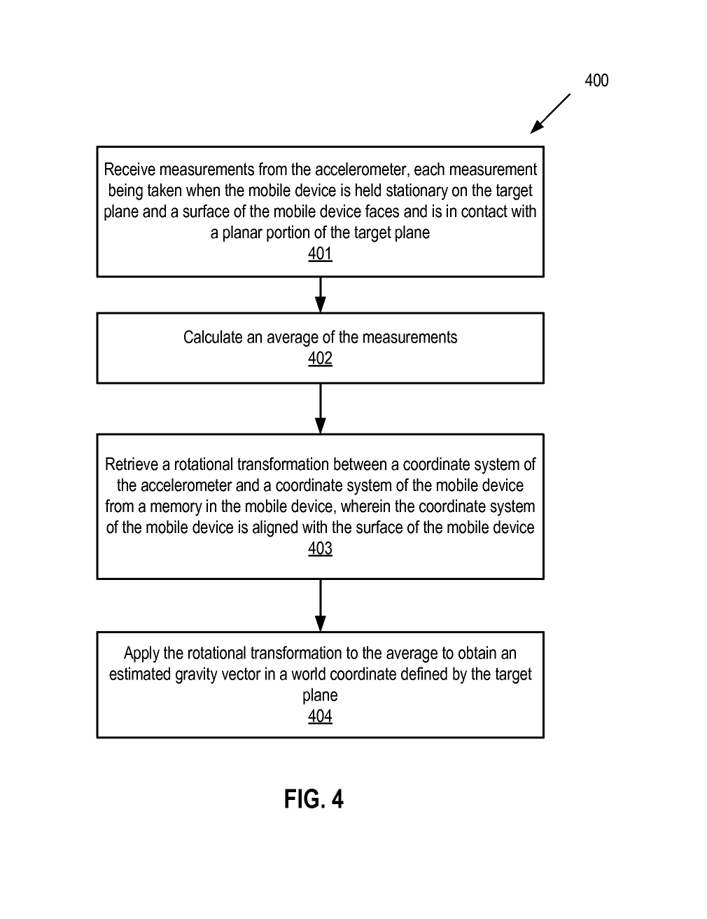

FIG. 4 illustrates an embodiment of a method 400 for estimating the gravity vector. In one embodiment, the method 400 is performed by a mobile device, such as the processor 110 of FIG. 1A, using the measurements of the accelerometer 130. In one embodiment, the method 400 may be performed by hardware, software, firmware, or a combination of any of the above.

In one embodiment, a processor of a mobile device receives a plurality of measurements from the accelerometer located within the mobile device (block 401). Each of the measurements is taken when the mobile device is held stationary on the target plane and a surface of the mobile device faces and is in contact with a planar portion of the target plane. The processor calculates an average of the measurements (block 402), and retrieves a rotational transformation between an accelerometer coordinate system and a device coordinate system from a memory in the mobile device (block 403), wherein the device coordinate system is aligned with the surface of the mobile device. Accelerometer bias, if any, is removed from the average of the measurements. The rotational transformation is applied to the averaged measurements (with the bias removed) to obtain an estimated gravity vector in a world coordinate system defined by the target plane (block 404).

In one embodiment, the mobile device 100 may run an application that prompts the user to place the device on a target plane in order to start estimation of the gravity vector relative to the target plane. The application may include instructions to direct the accelerometer 130 to take multiple measurements upon receiving a trigger from a user, and/or when the accelerometer 130 senses that the device is stationary. After applying the rotational transformation to the measurements according to the method 400, the application may use the estimated gravity vector in the world coordinate system to compute additional parameters for AR, SLAM applications or other purposes, such as accelerator (and gyroscope) assisted AR, map building in SLAM, dynamic objects handling in SLAM, aligning SLAM maps to a horizontal coordinate system, and the like.

For example, when a user wants to localize the mobile device 100 relative to the world (i.e., a target plane), one additional parameter that the mobile device 100 may compute is the position vector of the mobile device 100 in the world coordinate system. The position vector indicates how far the mobile device 100 is from the origin of the world coordinate system and which direction the mobile device 100 is moving. The position vector can be computed using the accelerometer 130 while the mobile device 100 is moving. The acceleration of the mobile device 100 in the world coordinate system can be extracted from the accelerometer measurements by subtracting the gravity vector relative to the target plane from the gravity vector measured by the accelerometer 130. The velocity of the mobile device 100 can be obtained by integrating the acceleration over time, and the position vector of the mobile device 100 can be obtained by integrating the velocity over time. The orientation of the mobile device 100 can be measured by the gyroscope 140 within the mobile device 100, which tracks angular rotation of the mobile device 100.

It should be appreciated that when the mobile device 100 described above is a wireless mobile device, it may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The techniques described herein can be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers Interim Standard (IS)-2000, IS-95 and IS-856 standards. A TDMA system can implement a radio technology such as Global System for Mobile Communications (GSM). An OFDMA system can implement a radio technology such as Evolved Universal Terrestrial Radio Access; (Evolved UTRA or E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDM®, etc. Universal Terrestrial Radio Access (UTRA) and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

The techniques described herein may be incorporated into (e.g., implemented within or performed by) a variety of mobile apparatuses (e.g., devices). For example, one or more aspects taught herein may be incorporated into a phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a point-of-sale device, an entertainment device, or any other suitable device. These devices may have different power and data requirements

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for estimating a gravity vector on a target plane using an accelerometer located within a mobile device, comprising:
receiving a plurality of measurements by a processor of the mobile device from the accelerometer, each of the measurements being taken when the mobile device is held stationary on the target plane and a surface of the mobile device faces and is in contact with a planar portion of the target plane;
calculating an average of the measurements;
retrieving a rotational transformation between a coordinate system of the accelerometer and a coordinate system of the mobile device from a memory in the mobile device, wherein the coordinate system of the mobile device is aligned with the surface of the mobile device; and
applying the rotational transformation to the average to obtain an estimated gravity vector in a world coordinate system defined by the target plane.

2. The method of claim 1, wherein the rotational transformation is calibrated by a factory manufacturing the mobile device or by a user of the mobile device.

3. The method of claim 1, further comprising: removing a bias of the accelerometer from the average of the measurements.

4. The method of claim 1, wherein the rotational transformation is a rotation matrix between accelerometer axes and the surface of the mobile device.

5. The method of claim 1, wherein the target plane is tilted with respect to a horizontal axis.

6. The method of claim 1, wherein the target plane is aligned to a horizontal axis or a vertical axis.

7. The method of claim 1, further comprising:
prompting a user of the mobile device to start estimation of the gravity vector relative to the target plane; and
starting the measurements by the accelerometer in response to a trigger from the user and upon detecting the mobile device is motionless.

8. The method of claim 1, further comprising:
selecting a front surface or a back surface of the mobile device as the surface that defines the coordinate system of the mobile device based on which one of the front surface and the back surface is placed and in contact with the target plane.

9. The method of claim 8, wherein selecting further comprises:
retrieving one of rotational transformations from the memory of the mobile device, wherein the rotational transformations in the memory include a first transformation between the coordinate system of the accelerometer and the front surface of the mobile device, and a second transformation between the coordinate system of the accelerometer and the back surface of the mobile device.

10. A mobile device comprising:
an accelerometer;
a memory to store a rotational transformation between a coordinate system of the accelerometer and a coordinate system of the mobile device; and
a processor coupled to the memory and the accelerometer, the processor configured to:
receive a plurality of measurements from the accelerometer, each of the measurements being taken when the mobile device is held stationary on a target plane and a surface of the mobile device faces and is in contact with a planar portion of the target plane;
calculate an average of the measurements;
retrieve the rotational transformation from the memory, wherein the coordinate system of the mobile device is aligned with the surface of the mobile device; and
apply the rotational transformation to the average to obtain an estimated gravity vector in a world coordinate system defined by the target plane.

11. The mobile device of claim 10, wherein the rotational transformation is calibrated by a factory manufacturing the mobile device or a user of the mobile device.

12. The mobile device of claim 10, wherein the processor is further configured to: remove a bias of the accelerometer from the average of the measurements.

13. The mobile device of claim 10, wherein the rotational transformation is a rotation matrix between accelerometer axes and the surface of the mobile device.

14. The mobile device of claim 10, wherein the mobile device is a mobile phone.

15. The mobile device of claim 10, wherein the surface of the mobile device is planar or concave.

16. The mobile device of claim 10, wherein the processor is further configured to:
prompt a user of the mobile device to start estimation of the gravity vector relative to the target plane; and
start the measurements of the accelerometer in response to a trigger from the user and upon detecting the mobile device is motionless.

17. The mobile device of claim 10, wherein the processor is further configured to select a front surface or a back surface of the mobile device as the surface that defines the coordinate system of the mobile device based on which one of the front surface and the back surface is placed and in contact with the target plane.

18. The mobile device of claim 17, wherein the memory stores rotational transformations that include a first transformation between the coordinate system of the accelerometer and the front surface of the mobile device, and a second transformation between the coordinate system of the accelerometer and the back surface of the mobile device, and wherein the processor is configured to retrieve one of the rotational transformations from the memory of the mobile device.

19. A computer program product comprising:
a computer-readable medium comprising code for:
receiving a plurality of measurements from an accelerometer in a mobile device, each of the measurements being taken when the mobile device is held stationary on a target plane and a surface of the mobile device faces and is in contact with a planar portion of the target plane;
calculating an average of the measurements;
retrieving a rotational transformation between a coordinate system of the accelerometer and a coordinate system of the mobile device from a memory in the mobile device, wherein the coordinate system of the mobile device is aligned with the surface of the mobile device; and
applying the rotational transformation to the average to obtain an estimated gravity vector in a world coordinate system defined by the target plane.

20. The computer program product of claim 19, wherein the rotational transformation is calibrated by a factory manufacturing the mobile device or a user of the mobile device.

21. The computer program product of claim 19, further comprising code for removing a bias of the accelerometer from the average of the measurements.

22. The computer program product of claim 19, wherein the rotational transformation is a rotation matrix between accelerometer axes and the surface of the mobile device.

23. The computer program product of claim 19, wherein the target plane is tilted with respect to a horizontal axis.

24. The computer program product of claim 19, wherein the target plane is aligned to a horizontal axis or a vertical axis.

25. The computer program product of claim 19, further comprising code for:
prompting a user of the mobile device to start estimation of the gravity vector relative to the target plane; and
starting the measurements by the accelerometer in response to a trigger from the user and upon detecting the mobile device is motionless.

26. The computer program product of claim 19, further comprising code for:
selecting a front surface or a back surface of the mobile device as the surface that defines the coordinate system of the mobile device based on which one of the front surface and the back surface is placed and in contact with the target plane.

27. The computer program product of claim 26, further comprising code for:
retrieving one of rotational transformations from the memory of the mobile device, wherein the rotational transformations in the memory include a first transformation between the coordinate system of the accelerometer and the front surface of the mobile device, and a second transformation between the coordinate system of the accelerometer and the back surface of the mobile device.

28. A mobile device comprising:
means for receiving a plurality of measurements from an accelerometer, each of the measurements being taken when the mobile device is held stationary on a target plane and a surface of the mobile device faces and is in contact with a planar portion of the target plane;
means for calculating an average of the measurements;
means for retrieving a rotational transformation between a coordinate system of the accelerometer and a coordinate system of the mobile device from a memory in the mobile device, wherein the coordinate system of the mobile device is aligned with the surface of the mobile device; and
means for applying the rotational transformation to the average to obtain an estimated gravity vector in a world coordinate system defined by the target plane.

29. The mobile device of claim 28, wherein the rotational transformation is calibrated by a factory manufacturing the mobile device or a user of the mobile device.

30. The mobile device of claim 28, further comprising: means for removing a bias of the accelerometer from the average of the measurements.

31. The mobile device of claim 28, wherein the rotational transformation is a rotation matrix between accelerometer axes and the surface of the mobile device.

32. The mobile device of claim 28, wherein the mobile device is a mobile phone.

33. The mobile device of claim 28, wherein the target plane is tilted with respect to a horizontal axis.

34. The mobile device of claim 28, wherein the target plane is aligned to a horizontal axis or a vertical axis.

35. The mobile device of claim 28, wherein the surface of the mobile device is planar or concave.

36. The mobile device of claim 28, further comprising:
means for prompting a user of the mobile device to start estimation of the gravity vector relative to the target plane; and
means for starting the measurements by the accelerometer in response to a trigger from the user and upon detecting the mobile device is motionless.

37. The mobile device of claim 28, further comprising:
means for selecting a front surface or a back surface of the mobile device as the surface that defines the coordinate system of the mobile device based on which one of the front surface and the back surface is placed and in contact with the target plane.

38. The mobile device of claim 37, further comprising:
means for retrieving one of rotational transformations from the memory of the mobile device, wherein the rotational transformations in the memory include a first transformation between the coordinate system of the accelerometer and the front surface of the mobile device, and a second transformation between the coordinate system of the accelerometer and the back surface of the mobile device.
